(19) United States
(12) Patent Application Publication
(10) Pub. No.: US 2025/0390787 A1
(43) Pub. Date: Dec. 25, 2025

(54) GENERATING DATA FOR MODEL TRAINING

(71) Applicant: Capital One Services, LLC, McLean, VA (US)

(72) Inventors: Jeremy GOODSITT, Champaign, IL (US); Michael DAVIS, Arlington, VA (US); Taylor TURNER, Richmond, VA (US); Kenny BEAN, Herndon, VA (US)

(73) Assignee: Capital One Services, LLC, McLean, VA (US)

(21) Appl. No.: 18/751,430

(22) Filed: Jun. 24, 2024

(51) Int. Cl. G06N 20/00

(52) U.S. Cl. CPC G06N 20/00

(57) ABSTRACT

Systems and methods for generating synthetic data samples. In some aspects, a system accesses first and second user data samples corresponding to a first and second period of time, respectively, and generates a first and second profile based on the user data samples, wherein the profiles comprise parameters representing metadata associated with corresponding user data samples. The system generates a new profile corresponding to an intermediary period of time between a first and second period of time, wherein the new profile comprises intra-profile and inter-profile parameters. The system determines (1) a value for each intra-profile parameter based on values of intra-profile parameters of the first and second profile and (2) the value for each inter-profile parameter based on a predicted value output of a model trained on a plurality of data profiles over time and generates synthetic data samples based on values of the inter-profile and intra-profile parameters.

### SUMMARY

User data may include information collected, stored, or processed about an individual or entity as they interact with a system, service, or platform. User data and aspects of user data are essential in providing insight when processed to identify patterns in underlying information for various fields and applications. In particular, user data can often be used to improve services, tailor experiences, train machine learning models, and the like. For example, user data may be used as part of training datasets to train machine models that can later be used, e.g., in healthcare to diagnose diseases or to predict patient outcomes. In fraud detection, such user data may be used to prevent fraudulent transactions from taking place and to identify, assess, or mitigate various risks associated with specific user behaviors. User data can be used in other critical tasks, such as to detect objects in self-driving vehicles, test software applications, predict trends, or effectively personalize a user's experience.

However, while user data is crucial in so many applications, the handling of user data raises several important concerns related to privacy and security. For example, if personal information is exposed, it may leave users vulnerable to identity theft. Further, usage of user data for various applications may lead to insufficient data control, lack of transparency, and surveillance and tracking based on excessive collection of user data for security and privacy-related reasons that may expose users to bad actors. As a result, synthetic data can be generated to have the characteristics of the underlying real user data but without the particular individual values that can be traced to any one person. However, problems arise when there are gaps in such data, such as large periods of time where such data is unavailable. One issue includes difficulty in imputing missing values for applications, such as training and personalization, because the original user data may be unavailable.

Furthermore, user data can often be complex due to the high volume of user data, the variety of sources, and/or the structure of the data. Relationships between parameters of user data can be difficult to understand due to the high dimensionality, non-linearity, and various interactions and dependencies of the parameters. Because of this, it is difficult to be able to synthesize data or ascertain a computationally efficient methodology for estimating values for missing values. Accordingly, a mechanism is desired that would enable users, such as machine learning engineers, to easily synthesize data that fill in gaps, especially where the relationship between different parameters is unknown, in a manner that is computation efficient.

One mechanism for doing so enables generation of synthetic data for a missing period of time based on real user data. The task of generating synthetic data can often be complicated by the various different, complex relationships between parameters of user data. For example, values for parameters such as intra-profile parameters generated based on values of the same parameter at different points in time and inter-profile parameters generated based on values of other parameters associated with the same period of time can be determined by first identifying the relationship of the new parameters to other parameters in the same period of time, or the same or other parameters in a different period of time. Values of the new parameter's characteristic of the missing period of time can subsequently be determined. Such synthesized data can be used to augment existing datasets for training models, to provide personalization without unnecessary information being exposed, or to anonymize data of users.

Therefore, methods and systems are described herein for generation of synthetic data based on a profile generated based on user data. A synthetic data generation system may be used to perform operations described herein.

In some aspects, a method for generating synthetic data samples for usage in machine learning comprises: receiving, from a remote device, a request for generating synthetic data samples corresponding to an intermediary period of time between a first period of time and a second period of time, wherein the synthetic data samples represent user data samples corresponding to the intermediary period of time; accessing a first plurality of user data samples corresponding to the first period of time and a second plurality of user data samples corresponding to the second period of time; generating a first profile based on the first plurality of user data samples corresponding to the first period of time and a second profile based on the second plurality of user data samples corresponding to the second period of time, wherein the first profile and second profile comprise parameters representing metadata associated with corresponding user data samples; generating a new profile corresponding to the intermediary period of time, wherein the new profile comprises (a) intra-profile parameters generated based on values of parameters of the first profile and the second profile and (b) inter-profile parameters generated based on values of parameters of the new profile; determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; generating the synthetic data samples based on values of the inter-profile parameters and values of the intra-profile parameters; and transmitting, to the remote device, the synthetic data samples for training machine learning models.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for synthetic data generation, e.g., for usage in model training, in accordance with one or more embodiments of this disclosure.

FIG. 2 illustrates an exemplary request for synthetic data generation, in accordance with one or more embodiments of this disclosure.

FIG. 3 illustrates an exemplary representation of a generated profile, in accordance with one or more embodiments of this disclosure.

FIG. 4 illustrates an exemplary machine learning model, in accordance with one or more embodiments of this disclosure.

FIG. 5 illustrates a file containing exemplary synthetic data samples, in accordance with one or more embodiments of this disclosure.

FIG. 6 illustrates a computing device that can be used for synthetic data generation, in accordance with one or more embodiments of this disclosure.

FIG. 7 is a flowchart of operations for synthetic data generation, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

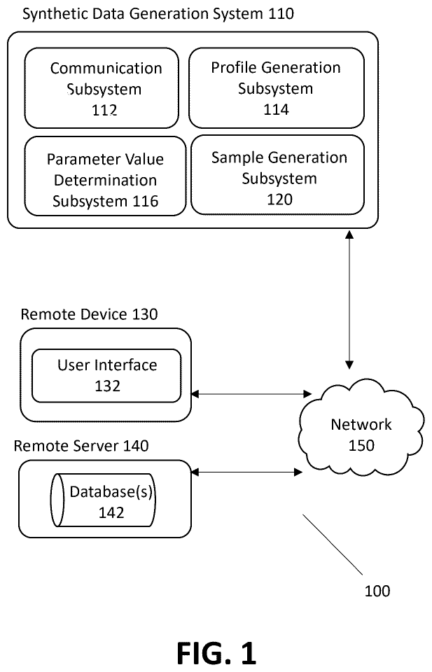

Environment 100 of FIG. 1 is an example system that may be used for synthetic data generation such as for periods of time where data is not available, in accordance with one or more embodiments of this disclosure. Data may be missing for many reasons. For example, data may not have been collected, e.g., in order to conserve computational expense, time, or space, or data may have been lost. Synthetic data generated using environment 100 may be used for various applications, such as in model training. Alternatively or additionally, the generated samples may consequently be used for usage as part of a remote workflow dependent on user samples. Environment 100 includes synthetic data generation system 110, remote device 130, and remote server 140. Synthetic data generation system 110 may execute instructions for synthetic data generation, for example, responsive to a request for generation.

Synthetic data generation system 110 may include software, hardware, or a combination of the two. For example, synthetic data generation system 110 may be a physical server or a virtual server that is running on a physical computer system. In some embodiments, synthetic data generation system 110 may be configured on a user device (e.g., a laptop computer, a smartphone, a desktop computer, an electronic tablet, or another suitable user device).

Synthetic data generation system 110 may receive a request to generate synthetic data corresponding to a period of time where data is missing. For example, the request may be generated or sent by a user, e.g., at a user device, or the request may be automatically submitted as part of a remote workflow. In some examples, the period of time where data is missing may be an intermediate period of time between two periods of time where data is available. The synthetic data generation system 110 may then generate profiles for periods of time where the data is available. The profiles may include values for parameters that characterize the available user data for each time period, so that the missing data can be approximated using those values.

For example, the synthetic data generation system 110 may then access user data samples from a first period of time and second period of time and generate profiles corresponding to each period of time. The profiles may include parameters representing metadata associated with corresponding user data samples. For example, they may include statistics, such as a mean, median, mode, range, etc. According to some examples, the synthetic data generation system 110 may receive and/or access user data via communication subsystem 112.

In some embodiments, synthetic data generation system 110 may receive the request using communication subsystem 112 as well. For example, synthetic data generation system 110 may receive the request from a user at a remote device 130 via user interface 132 or from database(s) 142 of remote server 140 via network 150. Network 150 may be a local area network (LAN), a wide area network (WAN; e.g., the internet), or a combination of the two. Communication subsystem 112 may include software components, hardware components, or a combination of both. For example, communication subsystem 112 may include a network card (e.g., a wireless network card and/or a wired network card) that is associated with software to drive the card. Communication subsystem 112 may pass at least a portion of the data of the request, or a pointer to the data in memory, to other subsystems such as profile generation subsystem 114, parameter value determination subsystem 116, or sample generation subsystem 120.

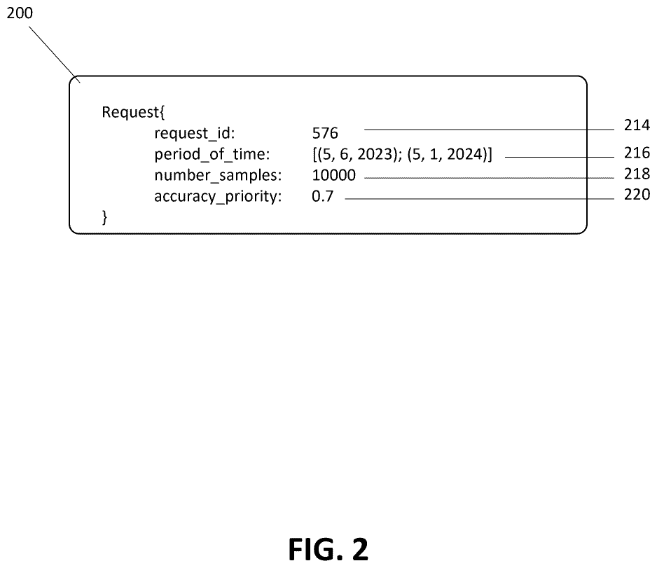

For example, FIG. 2 illustrates an exemplary request for synthetic data generation, in accordance with one or more embodiments of this disclosure. The request 200 may include data such as a request identifier 214 labeled “request_id,” which identifies the request. The request may include any alphanumeric string unique to each request instance that may be used to identify the request. The request 200 may also include the period of time 216 for which synthetic data samples are being requested for generation, e.g., the period of time for which data samples are missing. In the example of FIG. 2, the period of time is denoted “[(5, 6, 2023); (5, 1, 2024)]” which indicates that the period of time for which the synthetic data samples are being requested is from May 6, 2023, to May 1, 2024.

The request 200 may also include the number of samples 218 being requested, as well as user preferences for efficiency, accuracy, or computational expense. For example, request 200 includes the priority that the requester (e.g., user) may place on accuracy. In some examples, the priority may be a decimal value out of 1. In other examples, the user may indicate their preference for efficiency or computation expense that may be used by the system to determine an interpolation method. For example, the request 200 includes a priority value for accuracy 220, which indicates that accuracy is a higher priority, e.g., 0.7 out of 1.0. In some examples, in order to determine the best interpolation method for usage, the system may consider a weighted value of the priorities of each parameter (e.g., accuracy) with the parameter.

As described herein, the communication subsystem 112 may also be used to access user data samples corresponding to different periods of time. For example, the system may receive user data samples from remote devices (e.g., remote device 130), or remote servers (e.g., remote server 140), e.g., via the network 150. According to some examples, the system may access a first plurality of user data samples corresponding to a first period of time and a second plurality of user data samples corresponding to a second period of time. In some examples, the user data samples may be sensitive or require security from malicious actors. The system may generate profiles representative of the user data points during a period of time, so as to obscure the individual data points from potential malicious actors.

Communication subsystem 112 may pass at least a portion of the request data and/or the user data samples, or a pointer to the data in memory, to profile generation subsystem 114. Profile generation subsystem 114 may be configured to generate profiles based on the identified values of the user data points. In some examples, the profile generation subsystem 114 may first generate a first profile based on the first plurality of user data samples corresponding to the first period of time and a second profile based on the second plurality of user data samples corresponding to the second period of time, wherein the first profile and second profile comprise parameters representing metadata associated with corresponding user data samples. The metadata may include values such as statistics, or characteristics of the data. The metadata can help represent the user data, such that synthetic data may be generated having the characteristics of the original user data underlying the profile, without needing to access the original user data and while maintaining the privacy of the users to whom the user data may otherwise be traceable. In some cases, the metadata may include statistics such as mean, median, mode, range, etc. but can also be more complex.

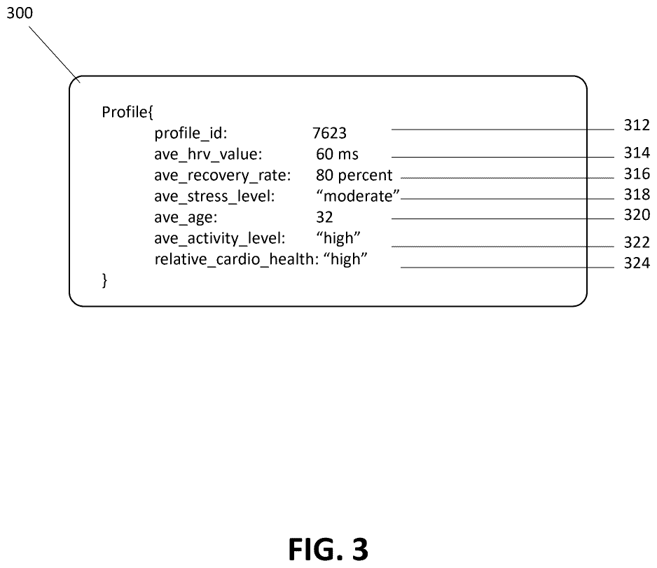

For example, FIG. 3 illustrates an exemplary representation of a generated profile, in accordance with one or more embodiments of this disclosure. For example, FIG. 3 includes a profile 300. The profile 300 may be identified in the system or remotely by the unique value of a profile identifier 312, “profile_id.” In some examples, the profile 300 may additionally include information as to the period of time that the profile corresponds to, e.g., by denoting start and end times, or by identifying the relative location in comparison to other periods of time.

Profile 300 also includes values for parameters such as average HRV value 314 “ave_hrv_value”, average recovery rate 316 “ave_recovery_rate”, average stress level 318 “ave_stress_level”, average age 320 “ave_age”, average activity level 322 “ave_activity_level”, and relative cardio health 324 “relative_cardio_health.” The parameters of the profile may depend on the type of user data collected, or the type of application for which it is to be used. For example, the user data may include many more values for parameters for each data sample, however, the synthetic data may be used for training models. In this case, only a subset of parameters may be used as feature parameters in training, so only a few parameters may be necessary in the profile.

For example, a user data sample may include values for average sleep, weight, BMI, steps walked daily, HRV, recovery rate, stress level, age, activity level, relative cardio health, etc. However, a machine learning model may only use feature parameters such as HRV, recovery rate, stress level, age, activity level, and relative cardio health. Because of this, the profile may include all parameters or simply the relevant subset of parameters used by the model. The system may then use one or more profiles to approximate the distribution of original user data in the dimensions (e.g., features) used by the model.

The profile generation subsystem 114 may then generate a new profile corresponding to an intermediary period of time between a first period of time and a second period of time. The intermediary period of time may be representative of a period of time where user data is missing or sparse. The new profile may include intra-profile parameters and inter-profile parameters. For examples, intra-profile parameters may include parameters having values generated based on values of parameters of other (e.g., existing) profiles, such as the first and second profile discussed herein. Inter-profile parameters may include parameters having values generated based on values of parameters of the new profile.

For example, age may decrease or increase monotonically between different periods of times. As such, age at an intermediate period of time may be approximated as an interpolation of the average age in a previous or subsequent period of time. In this example, age may be considered an intra-profile parameter. By contrast, some parameters may depend on values of other parameters of the same period of time and/or user. For example, stress level of a user may be a function or otherwise rely on the value of age, recovery rate, and activity level. In this example, stress level can be considered an inter-profile parameter.

The profile generation subsystem 114 may transmit data for the first and second profiles, or to a pointer in memory to the data, to parameter value determination subsystem 116. The parameter value determination subsystem 116 may determine values for each of the parameters (e.g., inter-profile and intra-profile parameters) for the new profile corresponding to the intermediate period of time. In some examples, values for each intra-profile parameter for the new profile may be based on values of intra-profile parameters of the first profile and the second profile and the value for each inter-profile parameter for the new profile may be based on a predicted value output of a machine learning model trained on a plurality of data profiles over time.

In some examples, the system may determine an interpolation method based on the user preferences, e.g., as indicated in the request, or separately by user input. For example, if the user preference indicates that accuracy is a higher priority than computational efficiency, the system may use the most computationally expensive interpolation method to ensure that accuracy is maximized. Alternatively, if the user preference indicates that computational efficiency is of a higher priority, the system may select the most computationally efficient method, e.g., that still determines values within a threshold value for confidence.

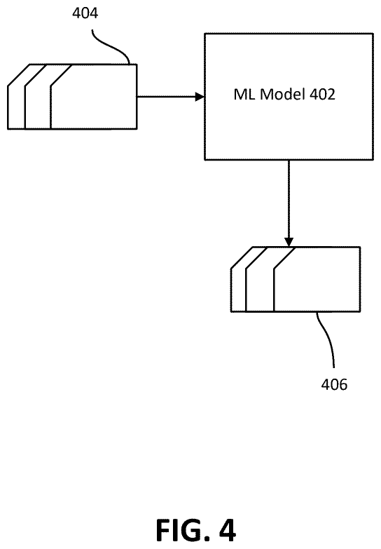

According to some examples, the system may access (e.g., via network 150 and communication subsystem 112) values for parameters for each of a plurality of data profiles, e.g., more than a first and second data profile, over time. The system may train a machine learning model to predict a value for an inter-profile parameter using the values of other parameters of the plurality of data profiles as predictor variables. Determining the value for each inter-profile parameter for the new profile may be based on the predicted value output of the machine learning model that comprises inputting values of intra-profile parameters of the new profile into the machine learning model. An exemplary machine learning model is discussed in further detail with relation to FIG. 4.

In some examples, determining a value for each intra-profile parameter for the new profile includes identifying a value of an intra-profile parameter for each of the plurality of data profiles and determining a method of interpolation to determine the value of the intra-profile parameter in the new profile based on variability of the value of the intra-profile parameter. For example, if the value of the parameter shows low variability between the different profiles, the system may select a simpler interpolation method, such as linear interpolation. By contrast, if the value of the parameter exhibits high variability between the different profiles, the system may select a more computationally expensive method to ensure accuracy, such as nearest neighbor, cubic spline interpolation, piecewise cubic hermite interpolation, thin-plate spline, or biharmonic interpolation method.

In some examples, determining a value for each inter-profile parameter for the new profile may include identifying a first value for an inter-profile parameter in the first profile and a second value for the inter-profile parameter in the second profile. Parameter value determination subsystem 116 may perform interpolation between the first value and second value based on a temporal position of the intermediary period of time in relation to the first period of time and the second period of time. For example, given a first parameter value of −100 for a first profile corresponding to a time period of 0-100 and a second value for the same parameter of 100 for a second profile corresponding to a time 100-200, if the intermediary period of time is 50-150, and the interpolation technique is linear, the system may determine that the parameter value for the new profile is 0 (e.g., the midpoint of −100 and 100). However, if the intermediary period of time is 75-175, and the interpolation technique is linear, the system may determine that the parameter value for the new profile is 50 based on the relative temporal position of the intermediary period of time of 75-175 to those corresponding to the first and second profile.

The parameter value determination subsystem 116 may then transmit the determined parameter values, or a pointer to the values in memory, to the profile generation subsystem 114. The profile generation subsystem 114 may use each of the determined parameter values to generate the intermediate profile. The intermediate profile may have the same or similar format as profile 300 of FIG. 3. The profile generation subsystem 114 and/or the parameter value determination subsystem 116 may transmit the parameter values, or a pointer to the values in memory, to the sample generation subsystem 120, which can be used to generate synthetic data samples configured to represent user data samples corresponding to the intermediary period of time. For example, the system may determine the synthetic data samples based on values of the inter-profile parameters and values of the intra-profile parameters.

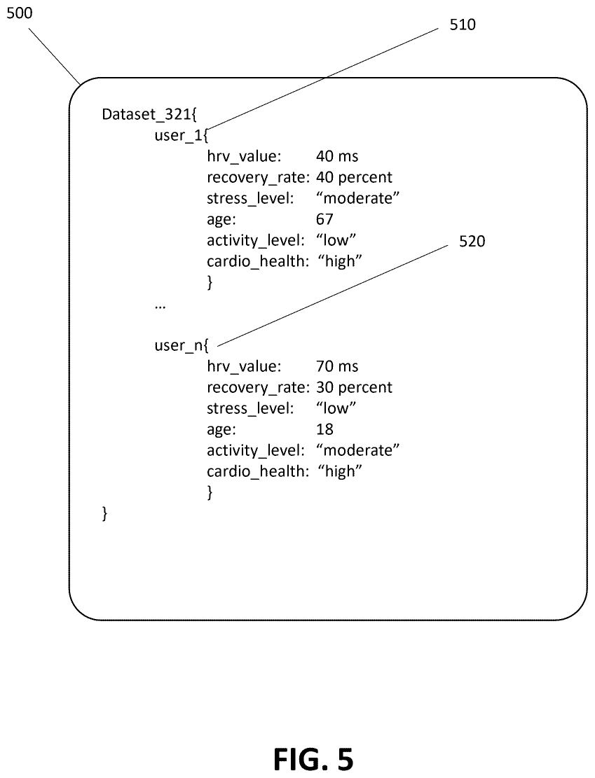

Sample generation subsystem 120 may compute, based on the values of parameters of the new profile, a probability distribution for the synthetic data samples. In some examples, the subsystem may then generate the synthetic data samples using a random number generator based on the probability distribution. FIG. 5 illustrates exemplary synthetic data, in accordance with one or more embodiments of this disclosure. FIG. 5 shows a file 500 including synthesized user data samples consistent with parameter values of the new profile. For example, sample 510 includes synthetic values for a first user, while sample 520 includes synthetic values for an nth user, where the number n of users may be determined based on predetermined values, or based on a value provided in the request, or dynamically determined based on the application for which the user data samples will be used.

According to some examples, determining values for inter-profile and/or intra-profile parameters may include using a plurality of values from various different profiles, e.g., more than two profiles, and using those values to determine the value for a profile parameter. For example, the system may use the plurality of values from various different profiles as key points of a spline in order to determine values of the inter-profile and/or intra-profile parameters. In one example, a spline includes a function defined piecewise by polynomials and values for the profile parameters, or the profile as a whole, may be used to determine different portions of the spline, e.g., as a function of time. In order to find the value for a profile parameter corresponding to the missing portion of time, the system may identify the value of the spline at the missing time and use that value as the value for the profile parameter.

For example, FIG. 4 illustrates an exemplary machine learning model 402 (e.g., the first and/or second machine learning model) that may use the synthetic data, e.g., for training. According to some examples, the machine learning model may be any model, such as a model for classification. For example, the machine learning model may be trained to intake input 404 including input data and receive, as a result of processing the input 404 via the machine learning model, an output 406. The machine learning model may have been trained on a training dataset containing different parameters of user data samples or profiles and corresponding value of a parameter acting as a target value. An exemplary machine learning model is described in relation to FIG. 4 herein.

The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback.

One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function that combines the values of all of its inputs together. Each connection (or the neural unit itself) may have a threshold function that a signal must surpass before it propagates to other neural units. The machine learning model may be self-learning and/or trained rather than explicitly programmed and may perform significantly better in certain areas of problem solving as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector. The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

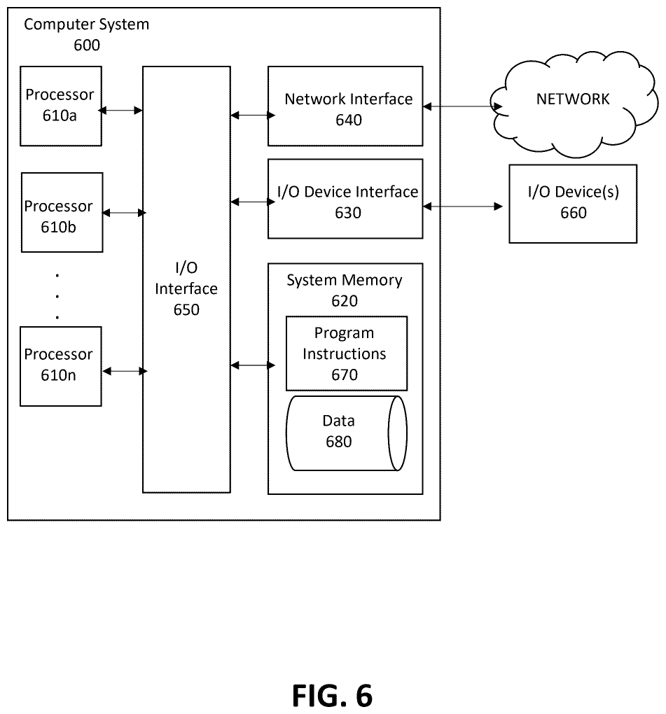

FIG. 6 shows an example computing system that may be used in accordance with some embodiments of this disclosure. In some instances, computer system 600 is referred to as a computing system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computer system 600. Further, processes and modules described herein may be executed by one or more processing systems similar to that of computer system 600.

Computer system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computer system 600. A processor may execute code (e.g., processor firmware, a protocol stack, a database management system, an operating system, or a combination thereof) that creates an execution environment for program instructions.

A processor may include a programmable processor. A processor may include general or special purpose microprocessors. A processor may receive instructions and data from a memory (e.g., system memory 620). Computer system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computer system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a LAN, a WAN, a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

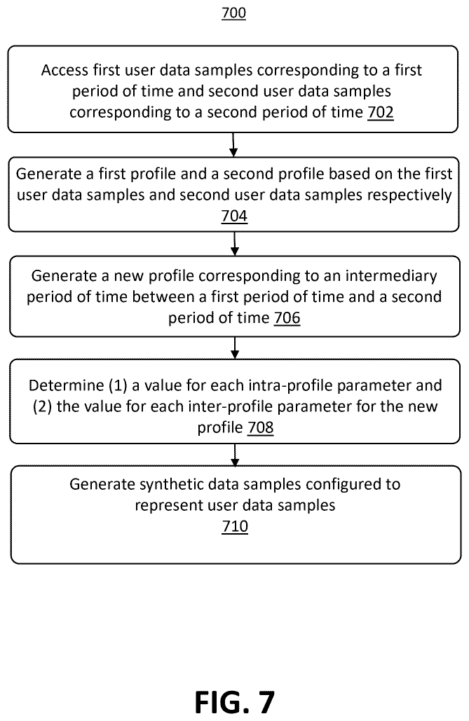

FIG. 7 is a flowchart 700 of operations for synthetic data generation, in accordance with one or more embodiments of this disclosure. The operations of FIG. 7 may use components described in relation to FIG. 6. In some embodiments, synthetic data generation system 110 may include one or more components of computer system 600.

At 702, synthetic data generation system 110 accesses first user data samples corresponding to a first period of time and second user data samples corresponding to a second period of time. Synthetic data generation system 110 may receive the data over network 150 using network interface 640.

For example, the synthetic data generation system 110 may do so responsive to receiving a request for generating synthetic data samples corresponding to the intermediary period of time between the first period of time and the second period of time. In some examples, the synthetic data samples are configured to represent user data samples corresponding to the intermediary period of time. According to some examples, the request may further include information such as a number of synthetic data samples to generate and/or user preferences for efficiency, accuracy, or computational expense.

At 704, synthetic data generation system 110 generates a first profile and a second profile based on the first user data samples and second user data samples respectively. For example, the synthetic data generation system 110 generates a first profile based on the first plurality of user data samples corresponding to the first period of time and a second profile based on the second plurality of user data samples corresponding to the second period of time, and the first profile and second profile may include parameters representing metadata associated with corresponding user data samples. Synthetic data generation system 110 may use one or more processors 610a, 610b, and/or 610n to perform the obtaining.

At 706, synthetic data generation system 110 generates a new profile corresponding to an intermediary period of time between a first period of time and a second period of time. For example, the synthetic data generation system 110 may generate a new profile corresponding to an intermediary period of time between a first period of time and a second period of time, wherein the new profile comprises (a) intra-profile parameters generated based on values of parameters of the first profile and the second profile and (b) inter-profile parameters generated based on values of parameters of the new profile. For example, synthetic data generation system 110 may use one or more processors 610a-610n to perform the operations.

At 708, synthetic data generation system 110 determines (1) a value for each intra-profile parameter and (2) the value for each inter-profile parameter for the new profile. For example, the synthetic data generation system 110 may determine the value for each intra-profile parameter for the new profile based on values of intra-profile parameters of the first profile and the second profile. The system may determine the value for each inter-profile parameter for the new profile based on a predicted value output of a machine learning model trained on a plurality of data profiles over time. For example, synthetic data generation system 110 may use one or more processors 610a-610n to perform the operations and may store the results in system memory 620.

At 710, synthetic data generation system 110 generates synthetic data samples configured to represent user data samples. For example, the synthetic data generation system 110 generates synthetic data samples configured to represent user data samples corresponding to the intermediary period of time based on values of the inter-profile parameters and values of the intra-profile parameters.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for generating synthetic data samples for usage in machine learning, the method comprising: receiving, from a remote device, a request for generating synthetic data samples corresponding to an intermediary period of time between a first period of time and a second period of time, wherein the synthetic data samples represent user data samples corresponding to the intermediary period of time; accessing a first plurality of user data samples corresponding to the first period of time and a second plurality of user data samples corresponding to the second period of time; generating a first profile based on the first plurality of user data samples corresponding to the first period of time and a second profile based on the second plurality of user data samples corresponding to the second period of time, wherein the first profile and second profile comprise parameters representing metadata associated with corresponding user data samples; generating a new profile corresponding to the intermediary period of time, wherein the new profile comprises (a) intra-profile parameters generated based on values of parameters of the first profile and the second profile and (b) inter-profile parameters generated based on values of parameters of the new profile; determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; generating the synthetic data samples based on values of the inter-profile parameters and values of the intra-profile parameters; and transmitting, to the remote device, the synthetic data samples for training machine learning models.
2. A method for generating synthetic data samples for usage in machine learning, the method comprising: accessing a first plurality of user data samples corresponding to a first period of time and a second plurality of user data samples corresponding to a second period of time; generating a first profile based on the first plurality of user data samples corresponding to the first period of time and a second profile based on the second plurality of user data samples corresponding to the second period of time, wherein the first profile and second profile comprise parameters representing metadata associated with corresponding user data samples; generating a new profile corresponding to an intermediary period of time between a first period of time and a second period of time, wherein the new profile comprises (a) intra-profile parameters generated based on values of parameters of the first profile and the second profile and (b) inter-profile parameters generated based on values of parameters of the new profile; determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; and generating synthetic data samples configured to represent user data samples corresponding to the intermediary period of time based on values of the inter-profile parameters and values of the intra-profile parameters.
3. A method for generating synthetic data samples for usage in machine learning, the method comprising: accessing a first plurality of user data samples corresponding to a first period of time and a second plurality of user data samples corresponding to a second period of time; generating a first profile based on the first plurality of user data samples corresponding to the first period of time and a second profile based on the second plurality of user data samples corresponding to the second period of time, wherein the first profile and second profile comprise parameters representing metadata associated with corresponding user data samples; generating a new profile corresponding to an intermediary period of time between a first period of time and a second period of time, wherein the new profile comprises (a) intra-profile parameters generated based on values of parameters of the first profile and the second profile and (b) inter-profile parameters generated based on values of parameters of the new profile; determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; and generating synthetic data samples configured to represent user data samples corresponding to the intermediary period of time based on values of the inter-profile parameters and values of the intra-profile parameters.
4. The method of any of the preceding embodiments, wherein the request further comprises user preferences for efficiency, accuracy, or computational load and wherein the instructions further cause operations comprising determining an interpolation method based on the user preferences.
5. The method of any of the preceding embodiments, wherein the request further comprises a number of synthetic data samples to generate and wherein the instructions further cause operations comprising: computing, based on the values of parameters of the new profile, a probability distribution for the synthetic data samples; and generating the synthetic data samples using a random number generator based on the probability distribution.
6. The method of any of the preceding embodiments, further comprising: training a first machine learning model using the dynamic features of the first subset of the set of features to identify object parameters associated with the objects that users are likely to interact with based on user-element interactions associated with the focus parameter; and training a second machine learning model using the stable features of the second subset of the set of features to identify the object parameters associated with the objects that the users are likely to interact with based on stable user-element interactions.
7. The method of any of the preceding embodiments, further comprising: accessing values for parameters for each of a plurality of data profiles over time; and training the machine learning model to predict a value for an inter-profile parameter using the values of other parameters of the plurality of data profiles as predictor variables.
8. The method of any of the preceding embodiments, wherein determining the value for each inter-profile parameter for the new profile based on the predicted value output of the machine learning model comprises inputting values of intra-profile parameters of the new profile into the machine learning model.
9. The method of any of the preceding embodiments, wherein determining a value for each inter-profile parameter for the new profile comprises: identifying a first value for an inter-profile parameter in the first profile and a second value for the inter-profile parameter in the second profile; and performing interpolation between the first value and second value based on a temporal position of the intermediary period of time in relation to the first period of time and the second period of time.
10. One or more tangible, non-transitory, computer-readable media storing instructions that, when executed by a data processing apparatus, cause the data processing apparatus to perform operations comprising those of any of embodiments 1-9.
11. A system comprising: one or more processors; and memory storing instructions that, when executed by the one or more processors, cause the processors to effectuate operations comprising those of any of embodiments 1-9.
12. A system comprising means for performing any of embodiments 1-9.
13. A system comprising cloud-based circuitry for performing any of embodiments 1-9.

What is claimed is:

1. A system for generating synthetic data samples for usage in machine learning, the system comprising:
one or more processors; and
one or more non-transitory, computer-readable media comprising instructions that, when executed by the one or more processors, cause operations comprising:
receiving, from a remote device, a request for generating synthetic data samples corresponding to an intermediary period of time between a first period of time and a second period of time, wherein the synthetic data samples represent user data samples corresponding to the intermediary period of time;
accessing a first plurality of user data samples corresponding to the first period of time and a second plurality of user data samples corresponding to the second period of time;
generating a first profile based on the first plurality of user data samples corresponding to the first period of time and a second profile based on the second plurality of user data samples corresponding to the second period of time, wherein the first profile and second profile comprise parameters representing metadata associated with corresponding user data samples;
generating a new profile corresponding to the intermediary period of time, wherein the new profile comprises (a) intra-profile parameters generated based on values of parameters of the first profile and the second profile and (b) inter-profile parameters generated based on values of parameters of the new profile;
determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time;
generating the synthetic data samples based on values of the inter-profile parameters and values of the intra-profile parameters; and
transmitting, to the remote device, the synthetic data samples for training machine learning models.

2. The system of claim 1, wherein the request further comprises user preferences for efficiency, accuracy, or computational load and wherein the instructions further cause operations comprising determining an interpolation method based on the user preferences.

3. The system of claim 1, wherein the request further comprises a number of synthetic data samples to generate and wherein the instructions further cause operations comprising:
computing, based on the values of parameters of the new profile, a probability distribution for the synthetic data samples; and
generating the synthetic data samples using a random number generator based on the probability distribution.

4. The system of claim 1, wherein the instructions further cause operations comprising:
accessing values for parameters for each of a plurality of data profiles over time; and
training the machine learning model to predict a value for an inter-profile parameter using the values of other parameters of the plurality of data profiles as predictor variables.

5. The system of claim 4, wherein determining the value for each inter-profile parameter for the new profile based on the predicted value output of the machine learning model comprises inputting values of intra-profile parameters of the new profile into the machine learning model.

6. The system of claim 1, wherein determining a value for each inter-profile parameter for the new profile comprises:
identifying a first value for an inter-profile parameter in the first profile and a second value for the inter-profile parameter in the second profile; and
performing interpolation between the first value and second value based on a temporal position of the intermediary period of time in relation to the first period of time and the second period of time.

7. A method for generating synthetic data samples, the method comprising:
accessing a first plurality of user data samples corresponding to a first period of time and a second plurality of user data samples corresponding to a second period of time;
generating a first profile based on the first plurality of user data samples corresponding to the first period of time and a second profile based on the second plurality of user data samples corresponding to the second period of time, wherein the first profile and second profile comprise parameters representing metadata associated with corresponding user data samples;
generating a new profile corresponding to an intermediary period of time between a first period of time and a second period of time, wherein the new profile comprises (a) intra-profile parameters generated based on values of parameters of the first profile and the second profile and (b) inter-profile parameters generated based on values of parameters of the new profile;
determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; and
generating synthetic data samples configured to represent user data samples corresponding to the intermediary period of time based on values of the inter-profile parameters and values of the intra-profile parameters.

8. The method of claim 7, further comprising receiving a request for generating synthetic data samples corresponding to the intermediary period of time between the first period of time and the second period of time, wherein the synthetic data samples are configured to represent user data samples corresponding to the intermediary period of time.

9. The method of claim 8, wherein the request further comprises a number of synthetic data samples to generate and wherein the method further comprises:
computing, based on the values of parameters of the new profile, a probability distribution for the synthetic data samples; and
generating the synthetic data samples using a random number generator based on the probability distribution.

10. The method of claim 8, wherein the request further comprises user preferences for efficiency, accuracy, or computational expense and wherein the method further comprises determining an interpolation method based on the user preferences.

11. The method of claim 7, further comprising:
accessing values for parameters for each of a plurality of data profiles over time; and
training the machine learning model to predict a value for an inter-profile parameter using the values of other parameters of the plurality of data profiles as predictor variables.

12. The method of claim 11, wherein determining the value for each inter-profile parameter for the new profile based on the predicted value output of the machine learning model comprises inputting values of intra-profile parameters of the new profile into the machine learning model.

13. The method of claim 7, wherein determining a value for each inter-profile parameter for the new profile comprises:
identifying a first value for an inter-profile parameter in the first profile and a second value for the inter-profile parameter in the second profile; and
performing interpolation between the first value and second value based on a temporal position of the intermediary period of time in relation to the first period of time and the second period of time.

14. The method of claim 13, wherein the method further comprises:
identifying a value of an intra-profile parameter for each of the plurality of data profiles; and
determining a method of interpolation to determine the value of the intra-profile parameter in the new profile based on variability of the value of the intra-profile parameter.

15. One or more non-transitory, computer-readable media comprising instructions recorded thereon that, when executed by one or more processors, cause operations for generating synthetic data samples for usage in machine learning, comprising:
accessing a first plurality of user data samples corresponding to a first period of time and a second plurality of user data samples corresponding to a second period of time;
generating a first profile based on the first plurality of user data samples corresponding to the first period of time and a second profile based on the second plurality of user data samples corresponding to the second period of time, wherein the first profile and second profile comprise parameters representing metadata associated with corresponding user data samples;
generating a new profile corresponding to an intermediary period of time between a first period of time and a second period of time, wherein the new profile comprises (a) intra-profile parameters generated based on values of parameters of the first profile and the second profile and (b) inter-profile parameters generated based on values of parameters of the new profile;
determining (1) a value for each intra-profile parameter for the new profile based on values of intra-profile parameters of the first profile and the second profile and (2) the value for each inter-profile parameter for the new profile based on a predicted value output of a machine learning model trained on a plurality of data profiles over time; and
generating synthetic data samples configured to represent user data samples corresponding to the intermediary period of time based on values of the inter-profile parameters and values of the intra-profile parameters.

16. The one or more non-transitory, computer-readable media of claim 15, wherein the instructions further cause operations comprising receiving a request for generating synthetic data samples corresponding to the intermediary period of time between the first period of time and the second period of time, wherein the synthetic data samples are configured to represent user data samples corresponding to the intermediary period of time.

17. The one or more non-transitory, computer-readable media of claim 16, wherein the request further comprises a number of synthetic data samples to generate and wherein the instructions further cause operations comprising:
computing, based on the values of parameters of the new profile, a probability distribution for the synthetic data samples; and
generating the synthetic data samples using a random number generator based on the probability distribution.

18. The one or more non-transitory, computer-readable media of claim 15, wherein the instructions further cause operations comprising:
accessing values for parameters for each of a plurality of data profiles over time; and
training the machine learning model to predict a value for an inter-profile parameter using the values of other parameters of the plurality of data profiles as predictor variables.

19. The one or more non-transitory, computer-readable media of claim 18, wherein determining the value for each inter-profile parameter for the new profile based on the predicted value output of the machine learning model comprises inputting values of intra-profile parameters of the new profile into the machine learning model.

20. The one or more non-transitory, computer-readable media of claim 15, wherein determining the value for each inter-profile parameter for the new profile comprises:
identifying a first value for an inter-profile parameter in the first profile and a second value for the inter-profile parameter in the second profile; and
performing interpolation between the first value and the second value based on a temporal position of the intermediary period of time in relation to the first period of time and the second period of time.
